(19) United States
(12) Patent Application Publication
(10) Pub. No.: US 2018/0138842 A1
(43) Pub. Date: May 17, 2018

(54) MOTOR AND MOTOR DRIVING CIRCUIT

(71) Applicant: Johnson Electric S.A., Murten (CH)

(72) Inventors: Chiping SUN, Hong Kong (CN); Xiuwen YANG, Shenzhen (CN); Shinghin YEUNG, Hong Kong (CN); Shujuan HUANG, Shenzhen (CN); Yunlong JIANG, Shenzhen (CN)

(21) Appl. No.: 15/812,192

(22) Filed: Nov. 14, 2017

(30) Foreign Application Priority Data
Nov. 15, 2016 (CN) 2016 1102 6877.3
Nov. 15, 2016 (CN) 2016 1103 6649.4

(51) Int. Cl. H02P 6/182; H02P 6/30; H02P 27/06; H02P 27/16; H02P 6/08; H02P 6/26

(52) U.S. Cl. CPC H02P 6/182; H02P 6/30; H02P 6/26; H02P 27/16; H02P 6/085; H02P 27/06

(57) ABSTRACT

A motor and a driving circuit thereof are provided. The motor driving circuit includes a controllable bidirectional AC switch connected with a winding of the motor between two terminals of an AC power supply; and first and second position sensors. The first position sensor and the second position sensor are respectively configured to detect positions of magnetic poles of the rotor. The first position sensor and the second position sensor output magnetic pole position signals having opposite phases when detecting a same magnetic pole of the rotor. At a rest position of the motor, the first position sensor and the second position sensor are respectively arranged with an advance angle with respect to a connection line crossing centers of opposite magnetic poles of the rotor, to make the motor have large starting torque.

### TECHNICAL FIELD

The present disclosure relates to the field of motor control, and in particular to a motor and a motor driving circuit.

### CROSS REFERENCE TO RELATED APPLICATIONS

This non-provisional patent application claims priority under 35 U. S. C. § 119(a) from Patent Application No. 201611026877.3 filed in the People's Republic of China on Nov. 15, 2016, and Patent Application No. 201611036649.4 filed in the People's Republic of China on Nov. 15, 2016, the entire contents of which are hereby incorporated by reference.

### BACKGROUND

In a starting process of a synchronous motor, an electromagnet of a stator generates an alternating magnetic field, dragging a permanent magnet rotor to oscillate. If the rotor obtains enough kinetic energy, oscillation amplitude of the rotor will keep increasing, and finally a rotation of the rotor will rapidly accelerate to be synchronous with the alternating magnetic field of the stator. In practice, when the motor starts from a rest position, in a starting stage of the motor, an alternating power supply changes a current flowing through a stator winding, based on an output of a Hall sensor. As the current flowing the stator winding does not change suddenly and increases slowly due to physical properties of the winding, an input power Pᵢₙₚᵤₜ (Pᵢₙₚᵤₜ=V_{Bemf}×Iₘₒₜₒᵣ, where V_{Bemf} is a back electromotive force, and Iₘₒₜₒᵣ is the current of the stator winding) also increases slowly. If the input power Pᵢₙₚᵤₜ is not large enough to overcome starting friction between a shaft and a shaft sleeve of the motor, and inertia of a motor load such as a pump or a fan, the motor will remain stationary and cannot start normally even if powered on.

### SUMMARY

In view of the above, it is necessary to provide a motor driving circuit, which provides large starting torque and controls forward (clockwise) and reverse (counterclockwise) rotations of a motor, and a motor including the motor driving circuit.

A motor driving circuit is provided according to an embodiment of the present disclosure, where the motor driving circuit is for driving a rotor of a motor to rotate with respect to a stator of the motor, and includes:

a controllable bidirectional AC switch, connected with a winding of the motor between two terminals of an AC power supply; and
a first position sensor and a second position sensor, respectively configured to detect positions of magnetic poles of the rotor, and output magnetic pole position signals having opposite phases when detecting a same magnetic pole of the rotor;
wherein at a rest position of the motor, the first position sensor and the second position sensor are respectively arranged with an advance angle with respect to a connection line crossing centers of opposite magnetic poles of the rotor.

A motor is provided according to an embodiment of the present disclosure, includes a stator, a rotor, and a motor driving circuit described above.

In the embodiments of the present disclosure, the position sensors are arranged by the advance angle along a circumference direction of the rotor. In this way, in a starting stage of the motor, a time for which the position sensors sense the current magnetic pole of the rotor is extended, and a current sinks into the stator winding at an earlier stage and/or the current sinks into the stator winding for a longer time. Therefore, input power of the motor is increased, making the motor generate large starting torque to overcome friction of a rotation shaft and inertia of a load to start smoothly, and greatly increasing efficiency of the motor.

### BRIEF DESCRIPTION OF THE DRAWINGS

In the drawings:

FIG. 1 is a schematic diagram of a circuit of a motor according to a first embodiment of the present disclosure;

FIG. 2 is a schematic diagram of an implementation of positions of a first Hall sensor and a second Hall sensor in FIG. 1 with respect to a rotor;

FIG. 3 is a schematic diagram of another implementation of positions of a first Hall sensor and a second Hall sensor in FIG. 1 with respect to a rotor;

FIG. 4 is a diagram of an operating principle of a Hall sensor;

FIG. 5 is a circuit diagram of an implementation of a rotational direction control circuit;

FIG. 6 is a schematic diagram of a circuit of a motor according to a second embodiment of the present disclosure;

FIG. 7 is a schematic diagram of a circuit of a motor according to a third embodiment of the present disclosure;

FIG. 8 is a schematic diagram of a circuit of a motor according to a fourth embodiment of the present disclosure;

FIG. 9 is a schematic diagram of a circuit of a motor according to a fifth embodiment of the present disclosure; and

FIG. 10A and FIG. 10B illustrate comparison diagrams of an input power of a motor according to the conventional technology and an input power of a motor according to an implementation of the present disclosure.

Hereinafter, specific implementations further illustrate the present disclosure in conjunction with the above drawings.

### DETAILED DESCRIPTION OF THE EMBODIMENTS

The technical solutions in embodiments of the present disclosure are described clearly and completely hereinafter in conjunction with the drawings in embodiments of the present disclosure. Apparently, the described embodiments are only some rather than all of the embodiments of the invention. All other embodiments obtained by those skilled in the art based on the embodiments of the present disclosure without any creative effort fall within the protection scope of the present disclosure. It can be understood that, the drawings are merely for reference and illustration, not to limit the invention. In the drawings, a displayed connection is merely for clear description, not to limit a connection manner.

It should be noted that, when a component is considered to be “connected” to another component, it may be directly connected to another component, or there may be an intermediate component. Unless otherwise defined, all the technical and scientific terms used herein have the same meaning as commonly understood by those skilled in the art to which the invention belongs. The terms used in the present disclosure are merely for describing specific embodiments, not to limit the invention.

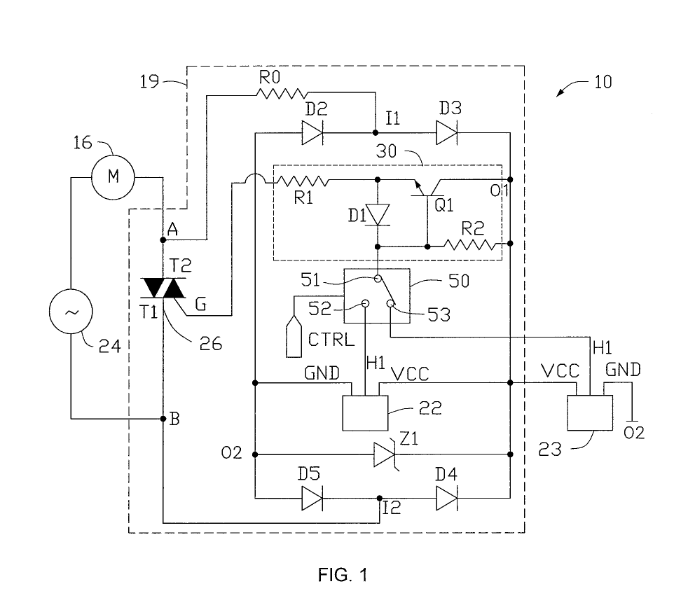

Referring to FIG. 1, which is a schematic diagram of a driving circuit of a motor 10 according to a first embodiment of the present disclosure. The motor 10 can rotate in two directions i.e. forward (clockwise) and reverse (counterclockwise) directions. The motor includes a stator and a rotor 11 rotatable relative to the stator. The stator includes a stator core and a stator winding 16 wound on the stator core. The stator core may be made of soft magnetic materials such as pure iron, cast iron, cast steel, electrical steel, silicon steel, and ferrite. The rotor 11 is a permanent magnet rotor, when the stator winding 16 is connected to an alternating current (AC) power supply 24, the rotor 11 operates at a constant rotational speed of 60f/p revolutions per minute during a steady state operation of the motor, wherein f is a frequency of the AC power supply, and p is the number of pole pairs of the rotor. In the embodiment, the stator core includes two poles (not shown) opposite to each other. Each of the poles includes a polar arc. An outside surface of the rotor is opposite to the polar arc, and a substantially uniform air gap is formed between the outside surface of the rotor and the polar arc. In the present disclosure, the substantially uniform air gap means that a uniform air gap is formed in most space between the stator and the rotor, and a non-uniform gap is formed only in a small part of the space between the stator and the rotor. Preferably, a concave starting groove is arranged in the polar arc of the pole of the stator, and the other part of the polar arc except the starting groove is concentric with the rotor 11. With the configuration described above, a non-uniform magnetic field may be formed, which makes the rotor 11 have starting torque every time the motor 10 is powered under the control of a motor driving circuit 19. In the embodiment, the stator and the rotor 11 each include two magnetic poles. It can be understood that, in more embodiments, the numbers of the magnetic poles of the stator may not be equal to the number of the magnetic poles of the rotor, and the stator and the rotor may include more magnetic poles, such as four or six magnetic poles.

The stator winding 16 of the motor 10 and the motor driving circuit 19 are connected in series between two terminals of the AC power supply 24. The motor driving circuit 19 may control forward and reverse rotations of the motor. The AC power supply 24 may be a commercial AC power supply of 220V, 230 V, or an AC power supply output from an inverter.

The motor driving circuit 19 includes a first detection circuit, a second detection circuit, a rectifier, a controllable bidirectional AC switch 26, a switch control circuit 30 and a rotational direction control circuit 50. The controllable bidirectional AC switch 26 is connected between a first node A and a second node B, and the stator winding 16 and the AC power supply 24 are connected in series between the first node A and the second node B. A first input terminal I1 of the rectifier is connected to the first node A through a resistor R0, and a second input terminal I2 of the rectifier is connected to the second node B. The rectifier is configured to convert the AC power supply into a direct current and supply the direct current to the first detection circuit and the second detection circuit.

In other implementations, the stator winding 16 and the controllable bidirectional AC switch 26 are connected in series between the first node A and the second node B, and the external AC power supply 24 is connected between the first node A and the second node B.

The first detection circuit and the second detection circuit respectively detect positions of the magnetic poles of the rotor 11 of the motor through detecting a strength of a magnetic field of the magnetic poles of the rotor, and output corresponding magnetic pole position signals, such as 5V and 0V, from their output terminals. The first detection circuit and the second detection circuit are preferably Hall sensors such as linear Hall sensors or switch type Hall sensors, which are denoted as a first Hall sensor 22 and a second Hall sensor 23 respectively in the implementation. It can be understood that, in other implementations, the first detection circuit and the second detection circuit may be photoelectric encoders. The first Hall sensor 22 and the second Hall sensor 23 each include a power supply terminal VCC, a ground terminal GND, and an output terminal H1. In this embodiment, the first Hall sensor 22 and the second Hall sensor 23 output the magnetic pole position signals having opposite phases when sensing the magnetic pole of the rotor 11 having the same polarity.

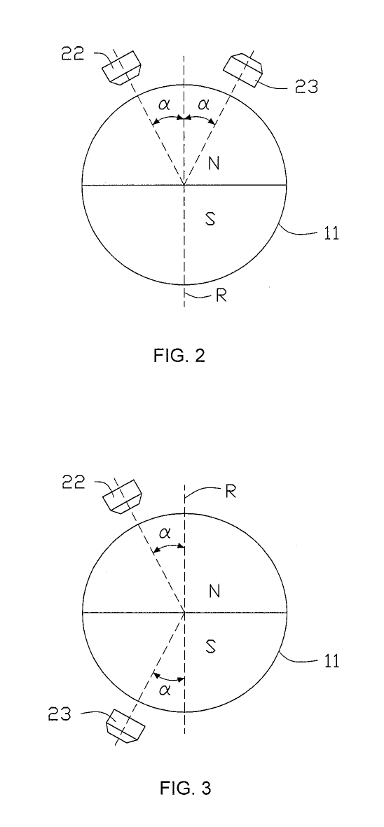

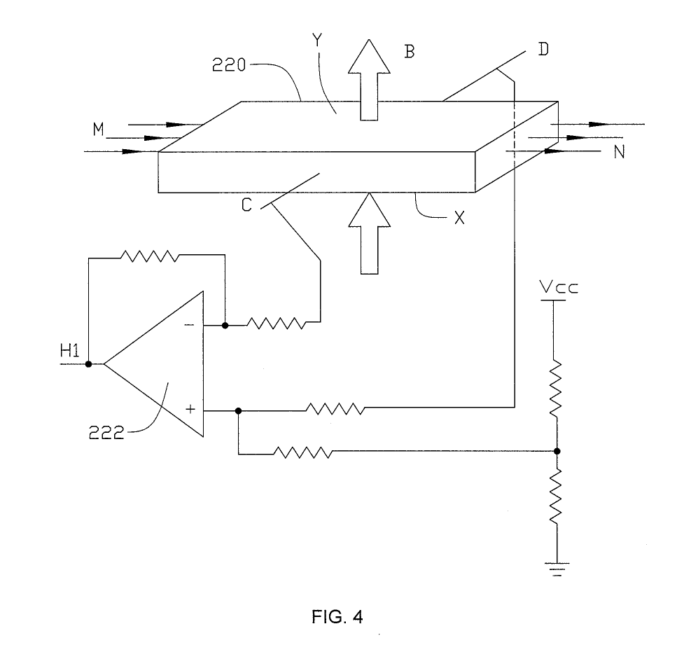

The first Hall sensor 22 and the second Hall sensor 23 have a same structure, and each is an integrated circuit including a housing. The housing includes a front wall and a rear wall, and a semiconductor plate, i.e., a Hall plate (hall plate) 220, and a signal amplifier 222 are received in the housing (see FIG. 4). Specifically, when the first Hall sensor 22 and the second Hall sensor 23 are arranged in the motor 10, the front wall of the first Hall sensor 22 faces the rotor 11, and the rear wall of the second Hall sensor 23 faces the rotor 11. At a rest position of the motor, the first Hall sensor 22 is arranged with a counterclockwise offset with respect to a polar axis R of the rotor 11, to form an advance angle; and the second Hall sensor 23 is arranged with a clockwise offset with respect to the polar axis R of the rotor 11, to form an advance angle. In the implementation, the two advance angles are equal to each other and both denoted as a. A virtual connection line crossing centers of the two opposite magnetic poles (i.e., two magnets in the present embodiment) of the rotor 11, which are in a radial direction, is denoted as the polar axis R of the rotor. In the embodiment shown in FIG. 2, the first Hall sensor 22 and the second Hall sensor 23 are arranged close to a same magnetic pole of the rotor 11, such as a north pole. In another embodiment, as shown in FIG. 3, the first Hall sensor 22 and the second Hall sensor 23 are arranged close to different magnetic poles of the rotor 11, for example, the first Hall sensor 22 is arranged close to the north pole of the rotor, and the second Hall sensor 23 is arranged close to the south pole of the rotor 11. It can be understood by those skilled in the art that, the rotor 11 may include multiple pairs of magnetic poles, and an electrical angle of the advance angle is smaller than 90 degrees/N, where N is the number of pairs of the magnetic poles of the rotor. In the implementation, a range of the advance angle α is greater than 0 degrees and less than 90 degrees. Preferably, the advance angle α is greater than or equal to 0 degrees, and is smaller than or equal to 45 degrees. More preferably, the advance angle may be 15 degrees, 20 degrees, 25 degrees, 30 degrees, 35 degrees or 40 degrees. When arranging the first Hall sensor 22 and the second Hall sensor 23 in the motor, at a predetermined rest position of the rotor, the first Hall sensor 22 and the second Hall sensor 23 are arranged away from a zero-crossing region of a magnetic field of the rotor, i.e., a region where the magnetic field of the rotor is weakest, to make the rotor start smoothly.

The rotational direction control circuit 50 is connected to the first Hall sensor 22 and the second Hall sensor 23, and is configured to selectively output, based on a rotational direction setting signal of the motor, the magnetic pole position signal from the first Hall sensor 22 or the magnetic pole position signal from the second Hall sensor 23, to the switch control circuit 30. The switch control circuit 30 controls, based on the received magnetic pole position signal and polarity information of the AC power supply, the controllable bidirectional AC switch 26 to switch between a turn-on state and a turn-off state in a predetermined manner, to control the forward rotation or the reverse rotation of the motor.

The rectifier includes four diodes D2 to D5. A cathode of the diode D2 is connected to an anode of the diode D3, a cathode of the diode D3 is connected to a cathode of the diode D4, an anode of the diode D4 is connected to a cathode of the diode D5, and an anode of the diode D5 is connected to an anode of the diode D2. The cathode of the diode D2 serves as the first input terminal I1 of the rectifier, and is connected to the first node A through the resistor R0. The resistor R0 may act as a voltage reducer. The anode of the diode D4 serves as the second input terminal I2 of the rectifier, and is connected to the second node B. The cathode of the diode D3 serves as a first output terminal O1 of the rectifier, and is connected to the power supply terminals VCC of the first Hall sensor 22 and the second Hall sensor 23. The first output terminal O1 outputs a high direct current operating voltage. The anode of the diode D5 serves as a second output terminal O2 of the rectifier, and is connected to the ground terminals GND of the first Hall sensor 22 and the second Hall sensor 23. The second output terminal O2 outputs a low voltage lower than the voltage of the first output terminal O1. A Zener diode Z1 is connected between the first output terminal O1 and the second output terminal O2 of the rectifier. An anode of the Zener diode Z1 is connected to the second output terminal O2, and a cathode of the Zener diode Z1 is connected to the first output terminal O1.

In this embodiment, the output terminals H1 of the first Hall sensor 22 and the second Hall sensor 23 are connected to the rotational direction control circuit 50. When the first Hall sensor 22 is normally powered, i.e., the power supply terminal VCC receiving a high voltage and the ground terminal GND receiving a low voltage, the output terminal H1 of the first Hall sensor 22 outputs the magnetic pole position signal at a logic high level if the detected magnetic field is north, and the output terminal H1 of the first Hall sensor 22 outputs the magnetic pole position signal at a logic low level if the detected magnetic field is south. When the second Hall sensor 23 is normally powered, i.e., the power supply terminal VCC receiving a high voltage and the ground terminal GND receiving a low voltage, the output terminal H1 of the second Hall sensor 23 outputs the magnetic pole position signal at a logic low level if the detected rotor magnetic field is north, and the output terminal H1 of the second Hall sensor 23 outputs the magnetic pole position signal at a logic high level if the detected magnetic field is south.

A principle of the first Hall sensor 22 and the second Hall sensor 23 outputting the magnetic pole position signals having the opposite phases when detecting the magnetic pole having a same polarity is described hereinafter. Referring to FIG. 4, the Hall plate 220 includes a front wall X and a rear wall Y. When the Hall plate 220 is packaged into the housing of the Hall sensor, the front wall X corresponds to the front wall of the housing of the Hall sensor, and the rear wall Y corresponds to the rear wall of the housing of the Hall sensor. The Hall plate 220 further includes two excitation current terminals M and N (corresponding to the power supply terminal VCC and the ground terminal GND in FIG. 1 respectively), and two Hall electromotive force output terminals C and D. Two input terminals of the signal amplifier 222 are connected to the two Hall electromotive force output terminals C and D respectively. A case that the first and second Hall sensors 22 and 23 both sense north of the rotor will be described as an example. As the front wall of the first Hall sensor 22 faces the rotor 11, the Hall plate 220 of the first Hall sensor 22 is in a magnetic field with a magnetic induction intensity of B when the magnetic pole of the rotor 11 is sensed to be a north pole. A direction of the magnetic field is upward and is perpendicular to the Hall plate 220, as shown in FIG. 4, where the direction of the magnetic field points from the front wall X to the rear wall Y of the Hall plate 220. When a current flowing from the excitation current terminal M to the excitation current terminal N flows through the Hall plate 220, electrons are deflected under Lorentz force, there are electrons accumulating at the Hall electromotive force output terminal C, and there is a lack of electrons at the Hall electromotive force output terminal D. Therefore, the Hall electromotive force output terminal C is negatively charged while the Hall electromotive force output terminal D is positively charged, and a Hall electromotive force is generated in a direction perpendicular to the current and the magnetic field, i.e., between the Hall electromotive force output terminals C and D. The signal amplifier 222 amplifies the Hall electromotive force and generates the magnetic pole position signal in a form of a digital signal. In this case, the magnetic pole position signal is a logic high level “1” which is output from the output terminal H1 of the first Hall sensor.

As the rear wall of the second Hall sensor 23 faces the rotor 11, the Hall plate 220 of the second Hall sensor 23 is in a magnetic field with a magnetic induction intensity of B when the magnetic pole of the rotor is sensed to be the north pole. A direction of the magnetic field is downward and is perpendicular to the Hall plate 220. As the second Hall sensor 23 is reversed with respect to the first Hall sensor 22, the direction of the magnetic field points from the rear wall Y to the front wall X of the Hall plate 220 when viewed form the second Hall sensor 23, and a direction in which the magnetic field crosses the Hall plate 220 is opposite to the direction in FIG. 4. When a current flowing from the excitation current terminal M to the excitation current terminal N flows through the Hall plate 220, there are electrons accumulating at the Hall electromotive force output terminal D, and there is a lack of electrons at the Hall electromotive force output terminal C. Therefore, the Hall electromotive force output terminal D is negatively charged while the Hall electromotive force output terminal C is positively charged, and a Hall electromotive force is generated in a direction perpendicular to the current and the magnetic field, i.e., between the Hall electromotive force output terminals C and D. The signal amplifier 222 amplifies the Hall electromotive force and generates the magnetic pole position signal in a form of a digital signal. In this case, the magnetic pole position signal is a logic low level “0” which is output from the output terminal H1 of the second Hall sensor.

When the first Hall sensor 22 and the second Hall sensor 23 sense the south pole of the rotor, the output terminal H1 of the first Hall sensor 22 outputs a logic low level, and the output terminal H1 of the second Hall sensor 23 outputs a logic high level, where the principle is similar to the above and will not be described in detail.

In summary, the first Hall sensor 22 is installed in the motor with the front wall facing the rotor, and the second Hall sensor 23 is installed in the motor with the rear wall facing the rotor, to make a direction in which the Hall plate in the second Hall sensor 23 faces the rotor 11 be rotated by 180 degrees with respect to a direction in which the Hall plate in the Hall sensor 22 faces the rotor 11. The first Hall sensor 22 and the second Hall sensor 23 output the magnetic pole position signals having opposite phases when sensing the magnetic pole with a same polarity.

Referring to FIG. 1 again, the rotational direction control circuit 50 includes a switch unit, and the switch unit includes first to third terminals 51 to 53. The first terminal 51 is connected to the switch control circuit 30, the second terminal 52 receives the magnetic pole position signal output by the first Hall sensor 22, and the third terminal 53 receives the magnetic pole position signal output by the second Hall sensor 23. The rotational direction control circuit 50 selectively connects the first terminal 51 to the second terminal 52 or the third terminal 53 based on a rotational direction setting signal CTRL.

The switch control circuit 30 includes first to third terminals, where the first terminal is connected to the first output terminal O1 of the rectifier, the second terminal is connected to the first terminal 51 of the rotational direction control circuit 50, and the third terminal is connected to a control electrode G of the controllable bidirectional AC switch 26. The switch control circuit 30 includes a resistor R2, an NPN transistor Q1, and a diode D1 and a resistor R1 which are connected in series between the first terminal 51 of the rotational direction control circuit 50 and the controllable bidirectional AC switch 26. A cathode of the diode D1 serves as the second terminal of the switch control circuit 30, and is connected to the first terminal 51 of the rotational direction control circuit 50. A terminal of the resistor R2 is connected to the first output terminal O1 of the rectifier 28, and the other terminal of the resistor R2 is connected to the cathode of the diode D1. A base of the NPN transistor Q1 is connected to the cathode of the diode D1, an emitter of the NPN transistor Q1 is connected to an anode of the diode D1, and a collector of the NPN transistor Q1 serves as the first terminal of the switch control circuit 30 and is connected to the first output terminal O1 of the rectifier. A terminal of the resistor R1, which is not connected to the diode D1, serves as the third terminal of the switch control circuit 30.

The controllable bidirectional AC switch 26 is preferably a triode for alternating current (TRIAC), a first anode T1 thereof is connected to the second node B, a second anode T2 thereof is connected to the first node A, and a control electrode G thereof is connected to the third terminal of the switch control circuit 30. It can be understood that, the controllable bidirectional AC switch 26 may include an electronic switch, which allows currents to flow in two directions, formed by one or more of a metal-oxide semiconductor field effect transistor, a silicon-controlled rectifier, a bidirectional triode thyristor, an insulated gate bipolar transistor, a bipolar junction transistor, a thyristor, and an optocoupler. Examples include: two metal-oxide semiconductor field effect transistors may form the controllable bidirectional AC switch; two silicon-controlled rectifiers may form the controllable bidirectional AC switch; two insulated gate bipolar transistors may form the controllable bidirectional AC switch; and two bipolar junction transistors can form the controllable bidirectional AC switch.

The switch control circuit 30 is configured to turn on the controllable bidirectional AC switch 26 in a case that the AC power supply is in a positive half-cycle and the second terminal of the switch control circuit 30 receives a first level, or in a case that the AC power supply is in a negative half-cycle and the second terminal switch control circuit 30 receives a second level; and turn off the controllable bidirectional AC switch 26 in a case that the AC power supply is in a negative half-cycle and the second terminal switch control circuit 30 receives the first level, or in a case that the AC power supply is in a positive half-cycle and the second terminal switch control circuit 30 receives the second level. Preferably, the first level is a logic high level, and the second level is a logic low level.

An operation principle of the motor driving circuit 19 controlling the forward and reverse rotations of the motor is described hereinafter.

According to electromagnetic theories, for a single phase permanent magnet motor, a rotational direction of the rotor of the motor can be changed by changing a conduction manner of the stator winding 16. If a polarity of the rotor sensed by a Hall sensor is north, and an AC power supply flowing through the stator winding 16 is in a positive half-cycle, the motor rotates reversely, for example, rotating counterclockwise (CCW). It can be understood that, if the polarity of the rotor sensed by the Hall sensor is still north, and the external AC power supply flowing through the stator winding 16 is in a negative half-cycle, the rotor of the motor rotates forward, for example, rotating clockwise (CW). An embodiment of the present disclosure is designed according to the principle that control of the forward rotation and reverse rotation of the motor is achieved by adjusting, based on the polarities of the rotor sensed by the first Hall sensor 22 and the second Hall sensor 23, a direction of the current flowing through the stator winding 16. In this embodiment, the first Hall sensor 22 and the second Hall sensor 23 output the magnetic pole position signals having opposite phases when sensing a same magnetic pole of the rotor, and the switch control circuit 30 controls, based on the magnetic pole position signal, the polarity of the AC power supply flowing through the stator winding 16, to control the rotational direction of the motor.

Table 1 is a function table of controlling clockwise or counterclockwise rotation of the motor based on the rotation direction setting signal CTRL.

TABLE 1

| rotation direction setting | selected detection | rotational direction |
|---|---|---|
| signal CTRL | circuit | of motor |
| 0 | first Hall sensor | counterclockwise |
| 1 | second Hall sensor | clockwise |

The forward rotation of the motor is taken as an example for illustration hereinafter. It is assumed that the rotational direction setting signal CTRL is at a logic high level “1”, the first terminal 51 of the rotational direction control circuit 50 is connected to the third terminal 53, and the switch control circuit 30 receives the magnetic pole position signal output by the second Hall sensor 23. When the motor is started, if the second Hall sensor 23 senses that the position of the magnetic pole of the rotor is north, the second Hall sensor 23 outputs the magnetic pole position signal of the logic low level “0”, the cathode of the diode D1 in the switch control circuit 30 receives the low level, and the NPN transistor Q1 is turned off. If the AC power supply is in a negative half-cycle when the motor starts, the AC power supply in the negative half-cycle flows through the control electrode G of the controllable bidirectional AC switch 26, the resistor R1 and the diode D1 to the ground, the controllable bidirectional AC switch 26 is turned on, and the rotor 11 starts to rotate clockwise. If the AC power supply is in a positive half-cycle when the motor starts, the AC power supply in the positive half-cycle cannot pass the NPN transistor Q1, there is no current flowing through the control electrode G of the controllable bidirectional AC switch 26, the controllable bidirectional AC switch 26 is not turned on, and the rotor 11 does not rotate.

If the second Hall sensor 23 senses that the position of the magnetic pole of the rotor is the south pole, the second Hall sensor 23 outputs the magnetic pole position signal of the logic high level “1” to the switch control circuit 30, the cathode of the diode D1 in the switch control circuit 30 receives the high level, and the NPN transistor Q1 is turned on. Therefore, the anode of the diode D1 is at a high level. If the AC power supply is in a negative half-cycle when the motor starts, the AC power supply in the negative half-cycle cannot pass the control electrode G of the controllable bidirectional AC switch 26 and the resistor R1, hence, the controllable bidirectional AC switch 26 is not turned on, and the rotor 11 does not rotate. If the AC power supply is in a positive half-cycle when the motor starts, the AC power supply in the positive half-cycle flows through the NPN transistor Q1 and the resistor R1 to the control electrode G of the controllable bidirectional AC switch 26, the controllable bidirectional AC switch 26 is turned on, the positive half-cycle of the AC power supply flows through the stator winding, and the rotor 11 rotates clockwise.

If the motor is to be controlled to rotate reversely, i.e., rotate counterclockwise, the rotational direction setting signal CTRL is change to a logic low level “0”, the first terminal 51 of the rotational direction control circuit 50 is connected to the second terminal 52, and the switch control circuit 30 receives the magnetic pole position signal output by the first Hall sensor 22. If the first Hall sensor 22 senses that the position of the magnetic pole of the rotor is the north pole, the output terminal H1 of the first Hall sensor 22 outputs the magnetic pole position signal of the logic high level “1”, and the NPN transistor Q1 is turned on. Therefore, the anode of the diode D1 is at a high level. If the AC power supply is in a negative half-cycle when the motor starts, the AC power supply in the negative half-cycle cannot pass the control electrode G of the controllable bidirectional AC 26 and the resistor R1, hence, the controllable bidirectional AC switch 26 is not turned on, and the rotor 11 does not rotate. If the AC power supply is in a positive half-cycle when the motor starts, the AC power supply in the positive half-cycle flows through the NPN transistor Q1 and the resistor R1 to the control electrode G of the controllable bidirectional AC switch 26, the controllable bidirectional AC switch 26 is turned on, and the rotor 11 starts and rotates counterclockwise.

If the first Hall sensor 22 senses that the position of the magnetic pole of the rotor is the south pole, the output terminal H1 of the first Hall sensor 22 outputs the magnetic pole position signal of the logic low level “0”, the cathode of the diode D1 in the switch control circuit 30 receives the logic low level, and the NPN transistor Q1 is turned off. If the AC power supply is in a negative half-cycle when the motor starts, the AC power supply in the negative half-cycle flows through the control electrode G of the controllable bidirectional AC switch 26, the resistor R1 and the diode D1, and is grounded, the controllable bidirectional AC switch 26 is turned on, the negative half-cycle of the AC power supply flows through the stator winding 16, and the rotor 11 starts and rotates counterclockwise. If the AC power supply is in a positive half-cycle when the motor starts, the AC power supply in the positive half-cycle cannot pass the NPN transistor Q1, there is no current flowing through the control electrode G of the controllable bidirectional AC switch 26, the controllable bidirectional AC switch 26 is not turned on, and the rotor 11 does not rotate.

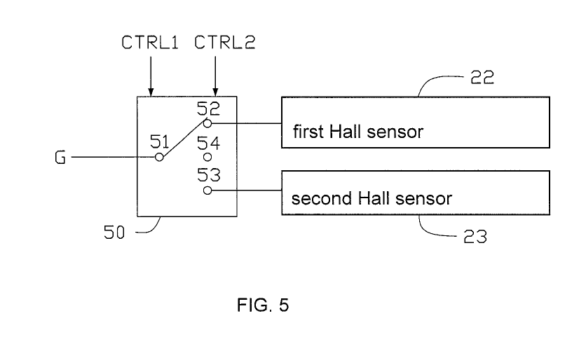

The situation that the rotor does not rotate described above happens when the motor is powered on. After the motor is started successfully, even if the controllable bidirectional AC switch 26 is not turned on, the rotor 11 will keep rotating under inertia. In addition, when changing the rotational direction of the rotor 11, it is required that the rotation of the rotor 11 of the motor is stopped first, to make the rotor 11 stop at a predetermined rest position. It is easy to stop the rotor 11 of the motor from rotating. For example, a switch (not shown) is added between the AC power supply 24 and the stator winding 16 of the motor, and the rotor 11 is stopped from rotating by turning off the switch for a predetermined time. There may be other implementations for stopping the rotor 11 of the motor from rotating. For example, referring to FIG. 5, the switch unit of the rotational direction control circuit 50 further includes a fourth terminal 54, the fourth terminal 54 is null, and a state of the rotational direction control circuit 50 is controlled by two rotational direction setting signals CTRL1 and CTRL2.

The following gives an embodiment to illustrate the process of changing the rotational direction of the motor. A user can output the rotational direction setting signals CTRL1=0 and CTRL2=0 to the rotational direction control circuit 50 via an external controller, the rotational direction control circuit 50 connects the first terminal 51 to the second terminal 52, the first Hall sensor 22 is selected to be connected to the switch control circuit 30, and the motor rotates counterclockwise. During the rotation of the motor, if the motor is to be controlled to change the rotational direction, the rotational direction control signals CTRL1=1 and CTRL2=1 may be output via the external controller, and the first terminal 51 of the rotational direction control circuit 50 is connected to the fourth terminal 54. As the fourth terminal 54 is null, there is no current flowing through the control electrode G of the controllable bidirectional AC switch 26, and the motor stops after rotating for a while under inertia. After a time, the external controller outputs the rotational direction control signals CTRL1=1 and CTRL2=0 to the rotational direction control circuit 50, the first terminal 51 of the rotational direction control circuit 50 is connected to the third terminal 53, the second Hall sensor 23 is selected to be connected to the switch control circuit 30, and the motor rotates clockwise.

Table 2 shows situations of controlling clockwise or counterclockwise rotation of the motor based on the rotational direction setting signal of the motor, the position of the magnetic pole of the rotor, and the polarity of the AC power supply.

TABLE 2

| | position of | output terminal | | |
|---|---|---|---|---|
| | magnetic | H1 of Hall | Polarity of AC | rotational direction of |
| | pole of rotor | sensor | power supply | motor |
| first | N | 1 | positive half-cycle | counterclockwise |
| Hall | S | 0 | negative half-cycle | counterclockwise |
| sensor | N | 1 | negative half-cycle | keep rotating under inertia |
| | S | 0 | positive half-cycle | keep rotating under inertia |
| second | N | 0 | negative half-cycle | clockwise |
| Hall | S | 1 | positive half-cycle | clockwise |
| sensor | N | 0 | positive half-cycle | keep rotating under inertia |
| | S | 1 | negative half-cycle | keep rotating under inertia |

In can be understood that, the switch control circuit 30, the rectifier, and the detection circuit may be integrated or packaged in an integrated circuit, such as an application-specific integrated circuit (ASIC), to reduce cost of the circuit and increase reliability of the circuit.

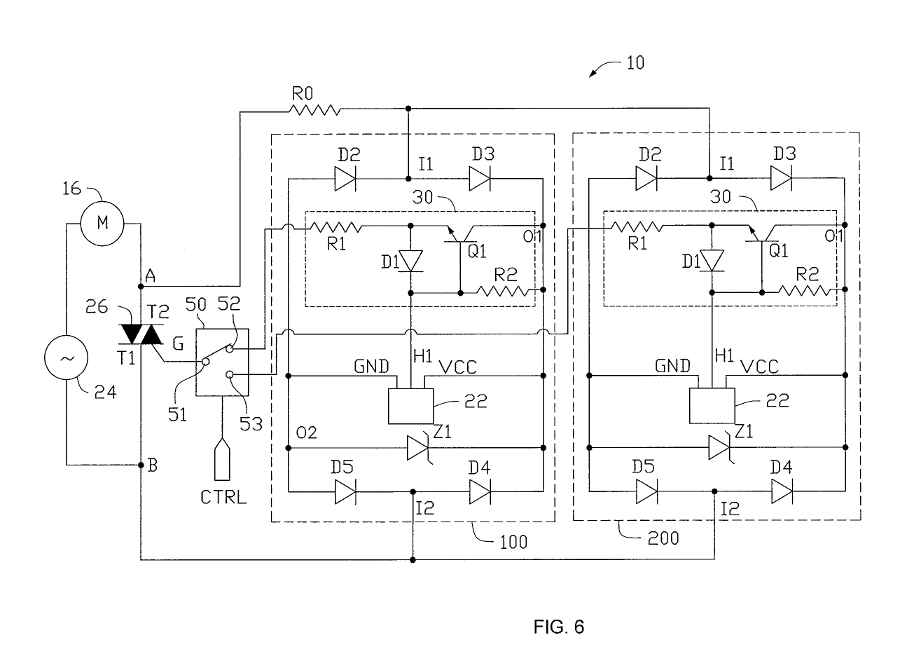

FIG. 6 is a circuit diagram of a motor according to a second embodiment of the present disclosure. The difference between the second embodiment and the first embodiment shown in FIG. 1 is that two motor driving integrated circuits (ICs) are adopted to control the motor to rotate clockwise or counterclockwise, and in each IC the switch control circuit 30, the rectifier and the detection circuit are integrated. The two motor driving integrated circuits are denoted as a first motor driving integrated circuit 100 and a second motor driving integrated circuit 200, respectively. The first motor driving integrated circuit 100 and the second motor driving integrated circuit 200 each includes a housing, the housing includes a front wall and a rear wall, the front wall of the first motor driving integrated circuit 100 faces the rotor 11, and the rear wall of the second motor driving integrated circuit 200 faces the rotor 11. At the rest position of the motor, the first motor driving integrated circuit 100 is arranged with a counterclockwise offset relative to the polar axis R of the rotor 11 to form an advance angle, and the second motor driving integrated circuit 200 is arranged with a clockwise offset relative to the polar axis R of the rotor 11 to form an advance angle. In the implementation, the two advance angles are equal to each other and both denoted as a. In the first motor driving integrated circuit 100 and the second motor driving integrated circuit 200, the output terminal H1 of the Hall sensor is directly connected the second terminal of the switch control circuit 30, which is different from the first implementation shown in FIG. 1. Structures and operating principles of the switch control circuits, the rectifiers and the detection circuits in the first motor driving integrated circuit 100 and the second motor driving integrated circuit 200 are the same as those in the first embodiment, which will not be described in detail herein. The rotational direction control circuit 50 is not integrated in the motor driving integrated circuits, and is configured to selectively output, based on the rotational direction setting signal of the motor, a control signal output by the first motor driving integrated circuit 100 or the second motor driving integrated circuit 200, to the controllable bidirectional AC switch 26, to control a turn-on state of the controllable bidirectional AC switch 26 and make the motor rotate in a predetermined direction or in a direction opposite to the predetermined direction. In the implementation, the predetermined direction is counterclockwise, and the direction opposite to the predetermined direction is clockwise.

In the implementation shown in FIG. 6, the first terminal 51 of the rotational direction control circuit 50 is connected to the control electrode G of the controllable bidirectional AC switch 26, the second terminal 52 of the rotational direction control circuit 50 is connected to the second terminal of the switch control circuit 30 in the first motor driving integrated circuit 100, and the third terminal 53 of the rotational direction control circuit 50 is connected to second terminal of the switch control circuit 30 in the second motor driving integrated circuit 200. The first input terminals I1 of the rectifiers of the first motor driving integrated circuit 100 and the second motor driving integrated circuit 200 are connected to the first node A through the resistor R0, and the second input terminals I2 of the rectifiers of the first motor driving integrated circuit 100 and the second motor driving integrated circuit 200 are connected to the second node B. The first anode T1 of the controllable bidirectional AC switch 26 is connected to the second node B, the second anode T2 is connected to the first node A, and the AC power supply 24 and the stator winding 16 are connected in series between the first node A and the second node B. In a case that the rotational direction control signal CTRL received by the rotational direction control circuit 50 is at a logic low level, the first terminal 51 is connected to the second terminal 52, and the motor rotates counterclockwise. In a case that the rotational direction control signal CTRL received by the rotational direction control circuit 50 is at a high logic level, the first terminal 51 of the rotational direction control circuit 50 is connected to the third terminal 53, and the motor rotates clockwise.

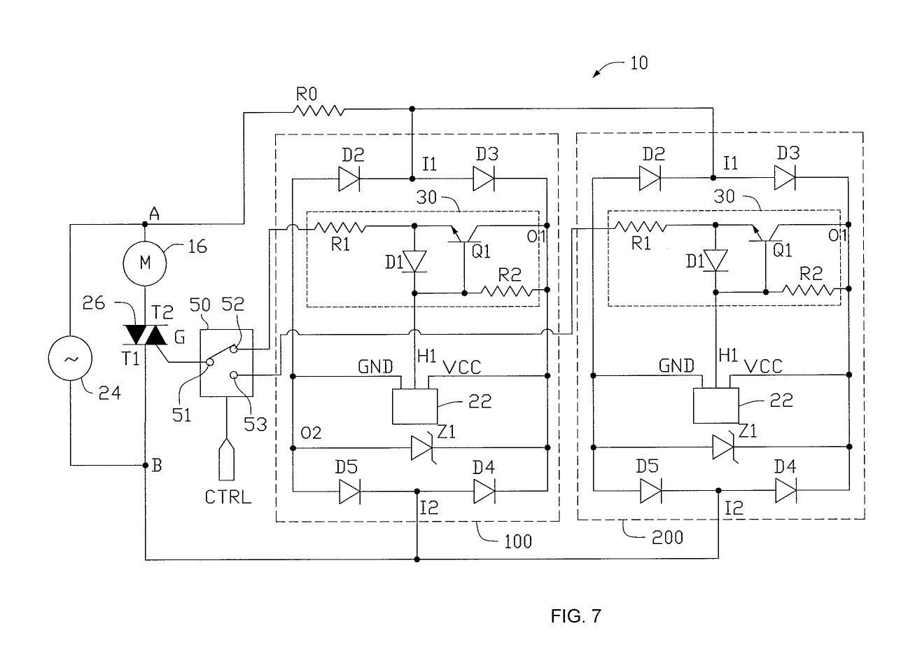

FIG. 7 is a circuit diagram of a motor according to a third embodiment of the present disclosure. The embodiment differs from the embodiment shown in FIG. 6 in that, the stator winding 16 and the controllable bidirectional AC switch 26 are connected in series between the first node A and the second node B, and the AC power supply 24 is connected between the first node A and the second node B.

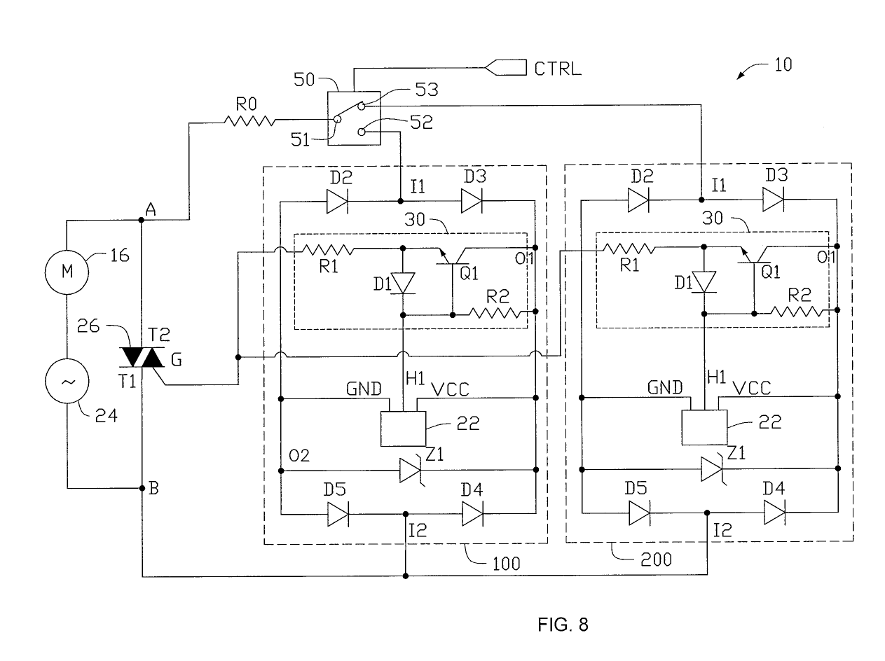

FIG. 8 is a circuit diagram of a motor driving circuit according to a fourth embodiment of the present disclosure. The embodiment differs from the embodiment shown in FIG. 6 in that a position of the rotational direction control circuit 50 is changed. In the embodiment, the first terminal 51 of the rotational direction control circuit 50 is connected to the first node A through the resistor R0, the second terminal 52 is connected to the first input terminal I1 of the rectifier of the first motor driving integrated circuit 100, and the third terminal 53 is connected to the first input terminal I1 of the rectifier of the second motor driving integrated circuit 200. The rotational direction control circuit 50 selectively controls, based on the rotational direction setting signal CTRL, the AC power supply 24 to supply power to the first motor driving integrated circuit 100 or the second motor driving integrated circuit 200, to output the control signal, output by the first motor driving integrated circuit 100 or the second motor driving integrated circuit 200, to the controllable bidirectional AC switch 26 to control the turn-on state of the controllable bidirectional AC switch 26, thereby controlling the motor to rotate forward or reversely.

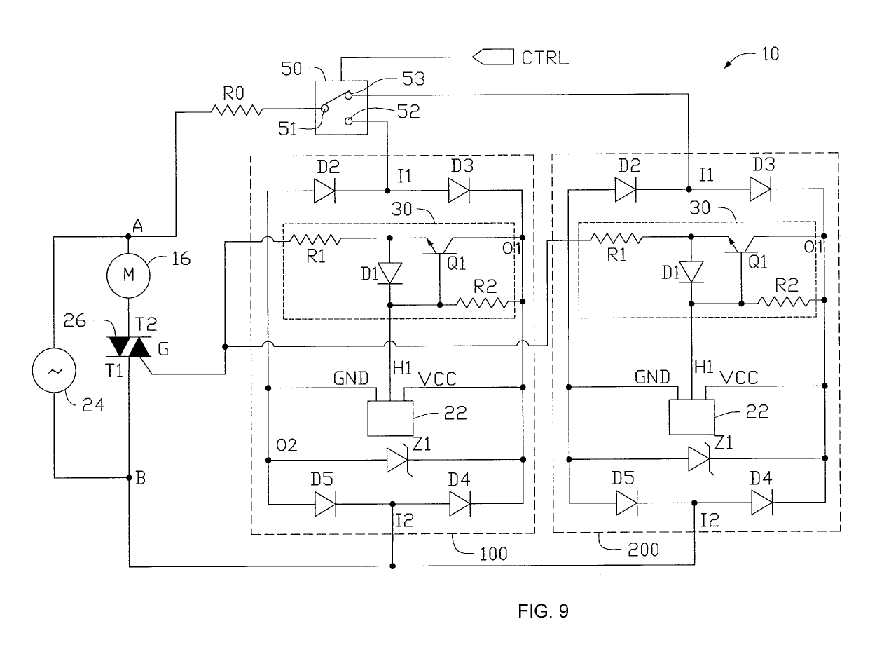

FIG. 9 is a circuit diagram of a motor driving circuit according to a fifth embodiment of the present disclosure. The difference between this embodiment and the embodiment shown in FIG. 8 is that, in this embodiment, the stator winding 16 and the controllable bidirectional AC switch 26 are connected in series between the first node A and the second node B, and the external AC power supply 24 is connected between the first node A and the second node B.

In the above implementations, the switch unit of the rotational direction control circuit 50 may be a mechanical switch or an electronic switch, where the mechanical switch includes a relay, a single-pole double-throw switch and a single-pole single-throw switch, and the electronic switch includes a solid state relay, a metal-oxide semiconductor field effect transistor, a silicon-controlled rectifier, a bidirectional triode thyristor, an insulated gate bipolar transistor, a bipolar junction transistor, a thyristor, and an optocoupler.

In can be understood by those skilled in the art that, in the embodiments shown in FIG. 6 to FIG. 9, the switch unit of the rotational direction control circuit 50 may be replaced by the switch unit shown in FIG. 5. When changing the motor rotational direction, the motor is controlled to stop rotating firstly via the rotational direction control circuit 50. It can be understood that other manners may be applied to controlling the motor to stop rotating. For example, a control switch (not shown) is added between the AC power supply 24 and the stator winding 16, and the rotor of the motor may be controlled, by turning off the control switch for a predetermined time, to stop rotating and stop at a predetermined rest position.

The motor driving circuit according to the embodiment of the present disclosure detects the positions of the magnetic poles of the rotor 11 via the two detection circuits or the two motor driving integrated circuits. The two detection circuits or the two motor driving integrated circuits output the magnetic pole position signals having opposite phases when detecting a same magnetic pole of the rotor. The rotational direction control circuit 50 selects, based on the rotational direction setting signal of the motor, the magnetic pole position signal or the control signal output by the corresponding detection circuit or the corresponding motor driving integrated circuit, to control the state of the controllable bidirectional AC switch and then control the direction of the current flowing through the stator winding of the motor, so as to control the forward rotation or the reverse rotation of the motor. The rotational direction of the motor can be changed by only switching the connecting terminals of the rotation direction control circuit 50. The motor driving circuit has a simple structure and a great universality.

In the above embodiments, at the rest position of the motor, the first Hall sensor 22 or the first motor driving integrated circuit 100 is arranged with the counterclockwise offset with respect to the polar axis R of the rotor 11, to form the advance angle; and the second Hall sensor 23 or the second motor driving integrated circuit 200 is arranged with the clockwise offset with respect to the polar axis R of the rotor 11, to form the advance angle. The arrangement of the advance angles is for making the motor have large starting torque when started.

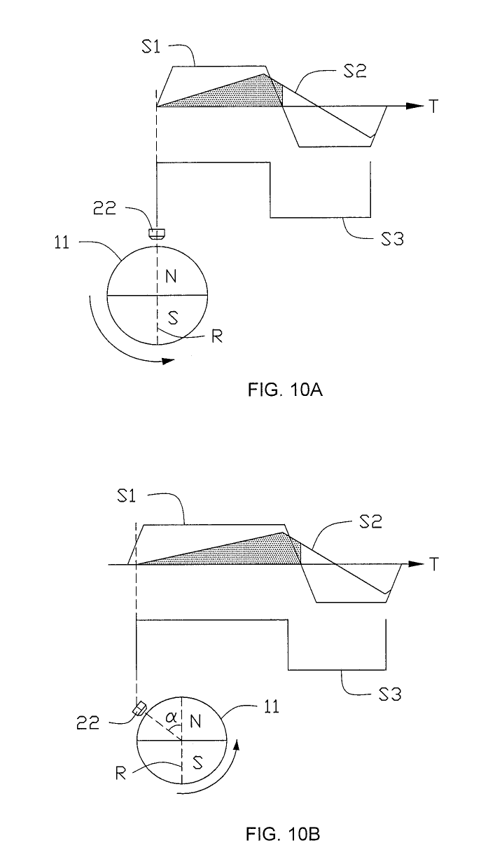

Hereinafter, the reverse rotation of the motor is taken as an example to illustrate a principle of providing the large starting torque. When the motor starts, the rotational direction control circuit 50 connects the first Hall sensor 22 or the first motor driving integrated circuit 100 to the motor, and the motor is powered on. If the first Hall sensor 22 or the first motor driving integrated circuit 100 detects that the magnetic field of the rotor is north, and if the AC power supply 24 is in a positive half-cycle, the switch control circuit 30 sends a signal to turn on the controllable bidirectional AC switch 26, hence, a winding current in the stator winding 16 of the motor gradually increases. As the first Hall sensor 22 or the first motor driving integrated circuit 100 is arranged with the counterclockwise offset with respect to the polar axis R of the rotor 11 to form the advance angle, a time for which the first Hall sensor 22 or the first motor driving integrated circuit 100 senses the present north of the rotor when the motor starts is extended, compared with that of a design according to the conventional technology in which a position sensor is arranged at the polar axis R of the rotor (as shown in FIG. 10A). The above can be seen from a comparison between FIG. 10A and FIG. 10B. In FIG. 10A and FIG. 10B, curves S1 indicate back electromotive forces, curves S2 indicate the winding currents, curves S3 indicate the magnetic pole position signals output by the position sensors, and shadows in the figures indicate input powers Pᵢₙₚᵤₜ of the motor. The input power Pᵢₙₚᵤₜ=V_{Bemf}×Iₘₒₜₒᵣ, where V_{Bemf} is the back electromotive force, and Iₘₒₜₒᵣ is the winding current of the stator. An area of the shadow in FIG. 10B is greatly increased compared with the area in FIG. 10A. The input power Pᵢₙₚᵤₜ is a means of generating mechanical work by the motor. After the input power Pᵢₙₚᵤₜ is increased, large starting torque is provided to overcome friction between a shaft and a shaft sleeve of the motor and inertia of a motor load such as a pump or a fan, to make the motor smoothly start and accelerate.

Similarly, when the motor rotates forward, the second Hall sensor 23 or the second motor driving integrated circuit 200 is arranged with the clockwise offset with respect to the polar axis R of the rotor 11 to form the advance angle, and large staring torque is also provided for the motor when the motor starts clockwise.

In the above embodiments, the rotor 11 is a permanent magnet rotor. Each pole of the permanent magnet rotor can be made of neodymium magnet material extracted from rare earth, or can be made of more durable materials such as rubber-wrapped neodymium magnet (also referred to rubber magnet). The back electromotive force of the motor can be trapezoidal wave. In other embodiments, the permanent magnet rotor may also be made of other materials such as ferrite, neodymium iron boron, alnico, etc. The waveform of the back electromotive force may also be a sine wave or the like.

In the above embodiments, the rectifier is a full bridge rectification circuit. In other implementations, a half bridge rectification circuit, a full-wave rectification circuit, a half-wave rectification circuit, or the like, may be adopted. In this embodiment, the rectified voltage is stabilized through the Zener diode Z1. In other embodiments, the voltage may be stabilized through electronic components such as a three terminal voltage stabilizer.

It can be understood that, the motor described in the embodiments of the present disclosure is suitable for driving devices such as a vehicle window and an office or household roller shutter. The motor according to the embodiments of the present disclosure is an AC motor with permanent magnet rotor, such as synchronous motor and brushless DC electric motor (BLDC motor). The motor according to the embodiments of the present disclosure is preferably a single-phase AC motor with permanent magnet rotor, such as a single-phase synchronous motor and a single-phase BLDC motor. When the motor is a synchronous motor; the AC power source may be commercial AC power supply. When the motor is a BLDC motor, the AC power source may be provided by an inverter.

Although certain inventive embodiments of the present disclosure have been specifically described, the present disclosure is not to be construed as being limited thereto. Various changes or modifications may be made to the present disclosure without departing from the scope and spirit of the present disclosure.

1. A motor driving circuit, for driving a rotor of a motor to rotate with respect to a stator, comprising:
a controllable bidirectional alternating current (AC) switch, connected with a winding of the motor between two terminals of an AC power supply; and
a first position sensor and a second position sensor, respectively configured to detect positions of magnetic poles of the rotor, and output magnetic pole position signals having opposite phases when detecting a same magnetic pole of the rotor;
wherein at a rest position of the motor, the first position sensor and the second position sensor are respectively arranged with an advance angle with respect to a connection line crossing centers of opposite magnetic poles of the rotor.

2. The motor driving circuit according to claim 1, further comprising: a rotational direction control circuit, connected to the first position sensor and the second position sensor, and configured to selectively output the magnetic pole position signal from the first position sensor or the magnetic pole position signal from the second position sensor to a switch control circuit, according to a rotational direction setting signal of the motor; wherein
the switch control circuit is configured to control the controllable bidirectional AC switch to be switched between a turn-on state and a turn-off state to control the motor to rotate in a predetermined direction or in a direction opposite to the predetermined direction, based on the received magnetic pole position signal and a polarity of the AC power supply; and the first position sensor comprises a first Hall sensor, and the second position sensor comprises a second Hall sensor.

3. The motor driving circuit according to claim 2, wherein the rotation direction control circuit outputs the magnetic pole position signal from the first detection circuit to the switch control circuit when the motor rotates in the predetermined direction; and the rotation direction control circuit outputs the magnetic pole position signal from the second detection circuit to the switch control circuit when the motor rotates in the direction opposite to the predetermined direction.

4. The motor driving circuit according to claim 2, wherein a direction in which a Hall plate in the first Hall sensor faces the rotor is rotated by 180 degrees with respect to a direction in which a Hall plate in the second Hall sensor faces the rotor.

5. The motor driving circuit according to claim 4, wherein at the rest position of the motor, when and only when the rotational direction of the motor is counterclockwise, the first Hall sensor is arranged with a counterclockwise offset with respect to the connection line crossing centers of opposite magnetic poles of the rotor, to form the advance angle; and when and only when the motor rotates clockwise, the second Hall sensor is arranged with a clockwise offset with respect to the connection line crossing centers of opposite magnetic poles of the rotor to form the advance angle.

6. The motor driving circuit according to claim 1, wherein an electrical angle of the advance angle is smaller than 90 degrees/N, and N is the number of pairs of the magnetic poles of the rotor.

7. The motor driving circuit according to claim 6, wherein the advance angle is greater than 0 degrees and less than 90 degrees.

8. The motor driving circuit according to claim 7, wherein the advance angle is 15 degrees, 20 degrees, 25 degrees, 30 degrees, 35 degrees, or 40 degrees.

9. The motor driving circuit according to claim 1, further comprising a control switch, wherein the control switch is connected between the AC power supply and the winding of the motor, and when changing the rotational direction of the motor during motor rotation, the control switch is firstly turned off for a predetermined time until the rotor stops at a predetermined rest position.

10. A motor, comprising a stator, a rotor, and a motor driving circuit, the motor driving circuit configured for driving the rotor of the motor to rotate with respect to the stator, comprising:
a controllable bidirectional alternating current (AC) switch, connected with a winding of the motor between two terminals of an AC power supply; and
a first position sensor and a second position sensor, respectively configured to detect positions of magnetic poles of the rotor, and output magnetic pole position signals having opposite phases when detecting a same magnetic pole of the rotor;
wherein at a rest position of the motor, the first position sensor and the second position sensor are respectively arranged with a counterclockwise offset with respect to the connection line crossing centers of opposite magnetic poles of the rotor.

11. The motor according to claim 10, further comprising: a rotational direction control circuit, connected to the first position sensor and the second position sensor, and configured to selectively output the magnetic pole position signal from the first position sensor or the magnetic pole position signal from the second position sensor to a switch control circuit, according to a rotational direction setting signal of the motor; wherein
the switch control circuit is configured to control the controllable bidirectional AC switch to be switched between a turn-on state and a turn-off state to control the motor to rotate in a predetermined direction or in a direction opposite to the predetermined direction, based on the received magnetic pole position signal and a polarity of the AC power supply.

12. The motor according to claim 10, wherein the motor is a single phase permanent magnet AC motor, a single phase permanent magnet synchronous motor, or a single phase permanent magnet brushless DC electric motor.
